(19) United States
(12) Patent Application Publication
(10) Pub. No.: US 2006/0245654 A1
(43) Pub. Date: Nov. 2, 2006

(54) Utilizing grammatical parsing for structured layout analysis

(75) Inventors: Paul A. Viola, Kirkland, WA (US); Michael Shilman, Seattle, WA (US); Mukund Narasimhan, Bellevue, WA (US); Percy S. Liang, Portland, OR (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/119,451

(22) Filed: Apr. 29, 2005

(51) Int. Cl. G06K 9/72; G06F 7/00

(52) U.S. Cl. 382/229; 707/102

(57) ABSTRACT

Grammatical parsing is utilized to parse structured layouts that are modeled as grammars. This type of parsing provides an optimal parse tree for the structured layout based on a grammatical cost function associated with a global search. Machine learning techniques facilitate in discriminatively selecting features and setting parameters in the grammatical parsing process. In one instance, labeled examples are parsed and a chart is generated. The chart is then converted into a subsequent set of labeled learning examples. Classifiers are then trained utilizing conventional machine learning and the subsequent example set. The classifiers are then employed to facilitate scoring of succedent sub-parses. A global reference grammar can also be established to facilitate in completing varying tasks without requiring additional grammar learning, substantially increasing the efficiency of the structured layout analysis techniques.

### TECHNICAL FIELD

The subject invention relates generally to recognition, and more particularly to systems and methods that employ grammatical parsing to facilitate in structured layout analysis.

### BACKGROUND OF THE INVENTION

Every day people become more dependent on computers to help with both work and leisure activities. However, computers operate in a digital domain that requires discrete states to be identified in order for information to be processed. This is contrary to humans who function in a distinctly analog manner where occurrences are never completely black or white, but in between shades of gray. Thus, a central distinction between digital and analog is that digital requires discrete states that are disjunct over time (e.g., distinct levels) while analog is continuous over time. As humans naturally operate in an analog fashion, computing technology has evolved to alleviate difficulties associated with interfacing humans to computers (e.g., digital computing interfaces) caused by the aforementioned temporal distinctions.

Technology first focused on attempting to input existing typewritten or typeset information into computers. Scanners or optical imagers were used, at first, to “digitize” pictures (e.g., input images into a computing system). Once images could be digitized into a computing system, it followed that printed or typeset material should be able to be digitized also. However, an image of a scanned page cannot be manipulated as text or symbols after it is brought into a computing system because it is not “recognized” by the system, i.e., the system does not understand the page. The characters and words are “pictures” and not actually editable text or symbols. To overcome this limitation for text, optical character recognition (OCR) technology was developed to utilize scanning technology to digitize text as an editable page. This technology worked reasonably well if a particular text font was utilized that allowed the OCR software to translate a scanned image into editable text.

Although text was “recognized” by the computing system, important additional information was lost by the process. This information included such things as formatting of the text, spacing of the text, orientation of the text, and general page layout and the like. Thus, if a page was double columned with a picture in the upper right corner, an OCR scanned page would become a grouping of text in a word processor without the double columns and picture. Or, if the picture was included, it typically ended up embedded at some random point between the texts. Other difficult examples include footnotes and figure captions. While it is possible to recognize the text using OCR, the OCR algorithm does not determine which text is a footnote (or caption). Thus, when the document is imported for editing, footnotes do not remain on the bottom of the page and captions wander away from the figures.

Users, who were at first happy to see that text could be recognized, soon wanted formatting and page layouts to also be “recognized” by computing systems. One of the problems with utilizing traditional pattern classification techniques for analyzing documents is that traditional text recognition methods are designed to classify each input into one of a finite number of classes. In contrast, the number of layout arrangements of a page are exponentially large. Thus, analyzing a document becomes exponentially more difficult due to the almost unlimited possibilities of layout choices. Users desire to obtain document analysis in an accurate, fast, and efficient manner so that traditional computing devices can be utilized to perform the analysis, negating the need to utilize large and costly devices.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to recognition, and more particularly to systems and methods that employ grammatical parsing to facilitate in structured layout analysis. A structured layout such as, for example, a document page is modeled as a grammar, and a global search for an optimal parse tree is then determined based on a grammatical cost function. Machine learning techniques are leveraged to facilitate in discriminatively selecting features and setting parameters in the grammatical parsing process. In one instance, labeled examples are parsed and a chart is generated. The chart is then converted into a subsequent set of labeled learning examples. Classifiers are then trained utilizing conventional machine learning and the subsequent example set. The classifiers are then employed to facilitate scoring of succedent sub-parses. A global reference grammar can also be established to facilitate in completing varying tasks without requiring additional grammar learning, substantially increasing the efficiency of the structured layout analysis techniques.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a structured layout analysis system in accordance with an aspect of the subject invention.

FIG. 2 is another block diagram of a structured layout analysis system in accordance with an aspect of the subject invention.

FIG. 3 is yet another block diagram of a structured layout analysis system in accordance with an aspect of the subject invention.

FIG. 4 is an illustration of an example structured layout in accordance with an aspect of the subject invention.

FIG. 5 is a flow diagram of a method of facilitating structured layout analysis in accordance with an aspect of the subject invention.

FIG. 6 is another flow diagram of a method of facilitating structured layout analysis in accordance with an aspect of the subject invention.

FIG. 7 illustrates an example operating environment in which the subject invention can function.

FIG. 8 illustrates another example operating environment in which the subject invention can function.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Systems and methods are provided for the hierarchical segmentation and labeling of structured layouts including, for example, handwritten and/or printed document layout structures and the like. A structured layout is modeled as a grammar, and a global search for the optimal parse is performed based on a grammatical cost function. Machine learning is then utilized to discriminatively select features and set all parameters in the grammatical parsing process. Thus, unlike many other prior approaches for structured layout analysis, the systems and methods can easily learn to adapt themselves to a variety of structured layout problems. This can be accomplished, for example, by specifying a page grammar for a document and providing a set of correctly labeled pages as training examples.

Parsing (or grammatical modeling) is a well known approach for processing computer languages and natural languages. In the case of computer languages, the grammar is unambiguous and given the input there is one and only one valid parse. In the case of natural languages, the grammar is ambiguous and given the input sequence there are a very large number of potential parses. The desire in statistical natural language parsing is to employ machine learning to yield a scoring function which assigns the highest score to the correct parse. Utilizing the subject invention, many types of structured layout processing problems such as, for example, document processing, can be viewed as a parsing task with a grammar utilized to describe a set of all possible layout structures. Thus, the systems and methods herein leverage this aspect to provide machine learning assisted scoring techniques adapted for structured layout analysis. These techniques can also utilize a “best parse” approach for quick determination instead of utilizing a more naïve approach wherein the score of all valid parses is computed.

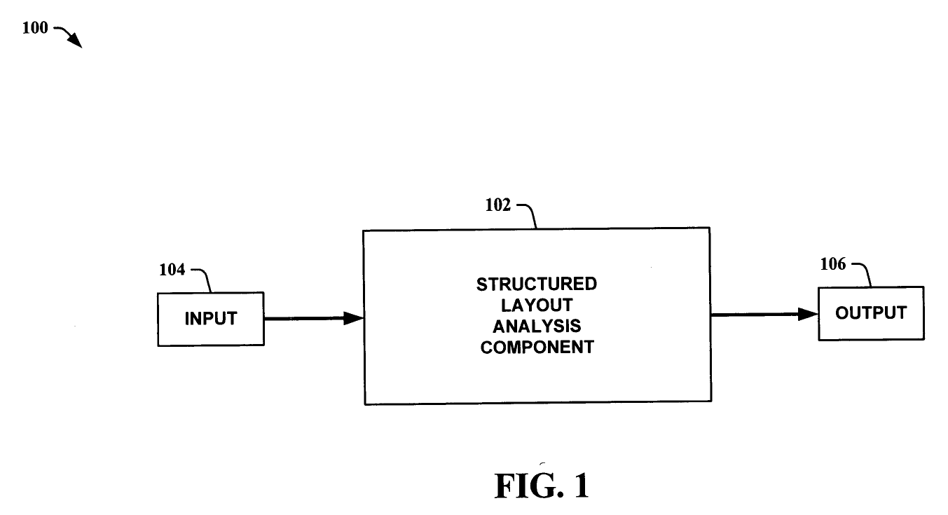

In FIG. 1, a block diagram of a structured layout analysis system 100 in accordance with an aspect of the subject invention is shown. The structured layout analysis system 100 is comprised of a structured layout analysis component 102 that receives an input 104 and provides an output 106. The structured layout analysis component 102 utilizes a non-generative grammatical model of a structured layout such as, for example, the layout of a handwritten and/or printed document and the like to facilitate in determining an optimal parse tree for the structured layout. The input 104 includes, for example, a labeled set of examples associated with the structured layout. The structured layout analysis component 102 parses the input 104 utilizing a grammatical parsing process that is facilitated by classifiers trained via machine learning to provide the output 106. The machine learning can include, but is not limited to, conventional machine learning and non-conventional machine learning and the like. The output 106 can be comprised of, for example, an optimal parse tree for the structured layout. The structured layout analysis component 102 typically employs learning in rounds where the classifiers are re-trained each round based on sub-parses of a prior round. This is described in more detail infra. The classifiers assist the parsing process by facilitating a grammatical cost function for a global search. A globally learned “reference” grammar can also be established to provide parsing solutions for different tasks without requiring additional grammar learning.

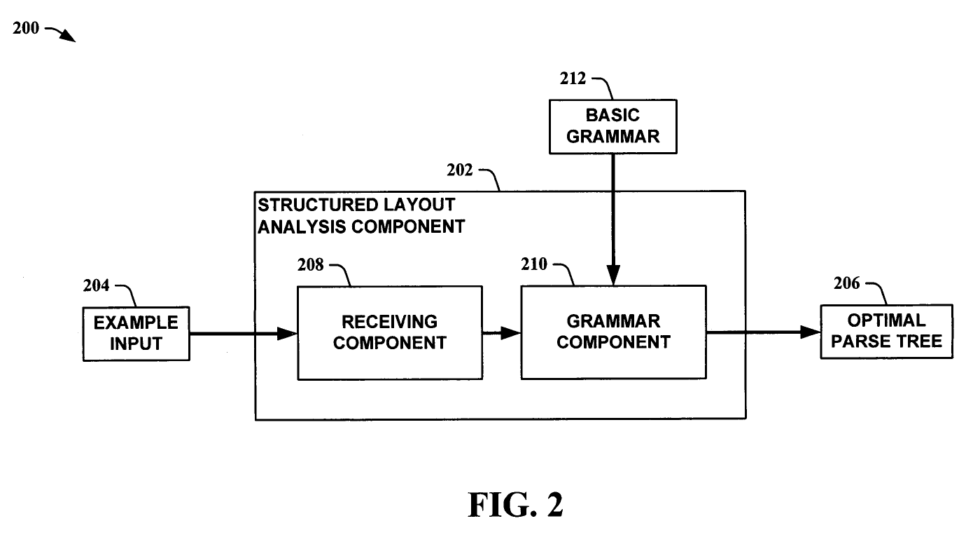

Look at FIG. 2, another block diagram of a structured layout analysis system 200 in accordance with an aspect of the subject invention is illustrated. The structured layout analysis system 200 is comprised of a structured layout analysis component 202 that receives an example input 204 and provides an optimal parse tree 206. The structured layout analysis component 202 utilizes a discriminative grammatical model of a structured layout. The structured layout analysis component 202 is comprised of a receiving component 208 and a grammar component 210. The receiving component 208 receives the example input 204 and relays it 204 to the grammar component 210. In other instances, the functionality of the receiving component 208 can be included in the grammar component 210, allowing the grammar component 210 to directly receive the example input 204. The grammar component 210 also receives a basic grammar input 212. The basic grammar input 212 provides an initial grammar framework for the structured layout. The grammar component 210 parses the example input 204 to obtain an optimal parse tree 206. It 210 accomplishes this via utilization of a grammatical parsing process that employs classifiers trained by conventional machine learning techniques (e.g., perceptron-based techniques and the like). The classifiers facilitate in iteratively scoring succedent sub-parses based on a global search. The cyclic nature of the process is described in detail infra. The grammar component 210 employs the dynamic programming process to determine a globally optimal parse tree. This prevents the optimal parse tree 206 from only being evaluated locally, yielding improved global results.

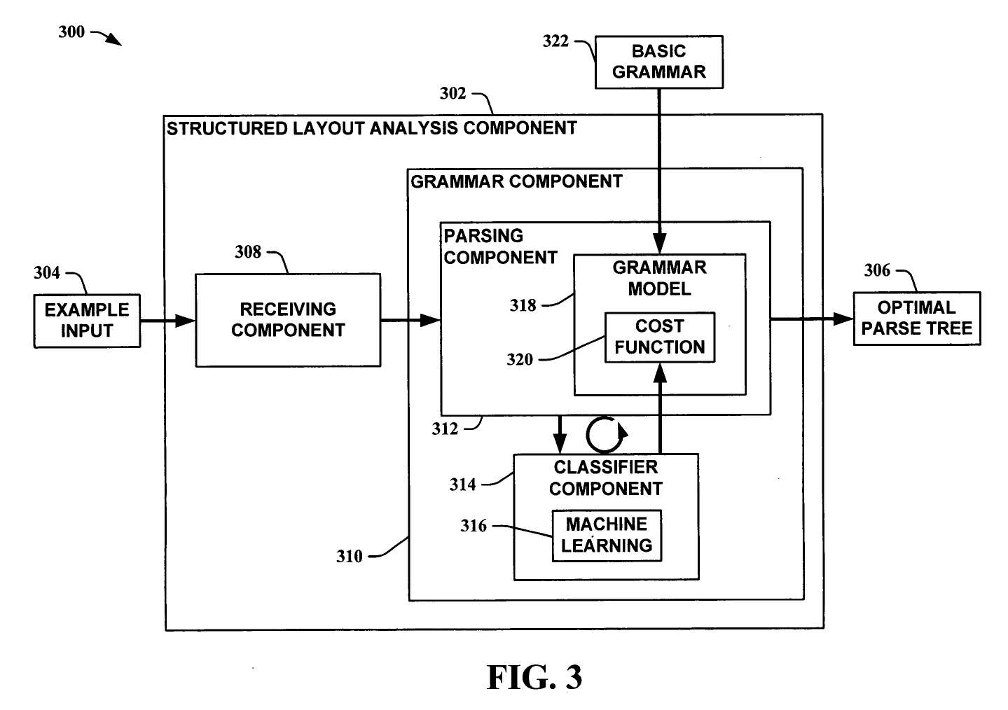

Turning to FIG. 3, yet another block diagram of a structured layout analysis system 300 in accordance with an aspect of the subject invention is depicted. The structured layout analysis system 300 is comprised of a structured layout analysis component 302 that receives an example input 304 and provides an optimal parse tree 306. The structured layout analysis component 302 utilizes a discriminative grammatical model of a structured layout for parsing. The structured layout analysis component 302 is comprised of a receiving component 308 and a grammar component 310. The grammar component 310 is comprised of a parsing component 312 and a classifier component 314 with machine learning 316. The parsing component 312 is comprised of a grammar model 318 with a grammatical cost function 320. The example input 304 includes, for example, a labeled set of examples associated with the structured layout. The receiving component 308 receives the example input 304 and relays it 304 to the parsing component 312. In other instances, the functionality of the receiving component 308 can be included in the parsing component 312, allowing the parsing component 312 to directly receive the example input 304. The parsing component 312 parses the set of labeled examples from the example input 304 based on a basic grammar input 322 in order to generate a chart. It 312 then converts the chart into a subsequent set of labeled examples that is relayed to the classifier component 314. The classifier component 314 utilizes the subsequent set of labeled examples along with machine learning 316 to train a set of classifiers. The classifier component 314 determines identifying properties between positive and negative examples of the example input 304. The identifying properties allow classifiers to facilitate in assigning proper costs to correct and/or incorrect parses. The parsing component 312 then utilizes the set of classifiers in the grammatical cost function 320 of the grammar model 318 to facilitate in scoring sub-parses of the subsequent set of labeled examples. In this manner, the process continues iteratively until an optimal parse tree 306 is obtained (e.g., no higher scoring parse tree is obtained or no lower cost parse tree is obtained). The optimal parse tree 306 is based on a global search.

Document Layout Analysis

A previous review of document structure analysis lists seventeen distinct approaches for the problem (see, S. Mao, A. Rosenfeld, and T. Kanungo, “Document structure analysis algorithms: A literature survey,” in Proc. SPIE Electronic Imaging, vol. 5010, January 2003, pp. 197-207). Perhaps the greatest difference between the published approaches is in the definition of the problem itself. One approach may extract the title, author, and abstract of a research paper (see, M. Krishnamoorthy, G. Nagy, S. Seth, and M. Viswanathan, “Syntactic segmentation and labeling of digitized pages from technical journals,” IEEE Transactions on Pattern Analysis and Machine Intelligence, vol. 15, pp. 737-747, 1993 and J. Kim, D. Le, and G. Thoma, “Automated labeling in document images,” in Document Recognition and Retrieval VIII, vol. 4307, January 2001). Another approach may extract the articles from a newspaper (see, D. Niyogi and S. Srihari, “Knowledge-based derivation of document logical structure,” in Third International Conference on Document Analysis and Recognition, Montreal, Canada, 1995). The seventeen approaches (and others published since the review) use widely varying algorithms as well. The majority of the approaches are not directly transferable from one task to another. Contrarily, the systems and methods provided here create a single framework which can be applied to new domains rapidly, with high confidence that the resulting system is efficient and reliable. This is in contrast to a number of previous systems where retargeting requires hand tuning many parameters and the selection of features for local distinctions. The systems and methods herein utilize machine leaning to set all parameters and to select a key subset of features from a large generic library of features. While the features selected for two different tasks can be different, the library itself can be utilized for a wide variety of tasks.

The approach for the systems and methods is to build a global hierarchical and recursive description of all observations of a structured layout (e.g., observations on a document page such as, for example, text or pixels or connected components). The set of all possible hierarchical structures is described compactly as a grammar. Dynamic programming is utilized to find the globally optimal parse tree for the page. Global optimization provides a principled technique for handling local ambiguity. The local interpretation which maximizes the global score is selected. Some previous approaches have used local algorithms which group characters/words/lines in a bottom up process. Bottom up algorithms are very fast, but are often brittle. The challenges of grammatical approaches include computational complexity, grammar design, feature selection, and parameter estimation.

Other earlier works on grammatical modeling of documents include P. Chou, “Recognition of equations using a two-dimensional stochastic context-free grammar,” in SPIE Conference on Visual Communications and Image Processing, Philadelphia, Pa., 1989; A. Conway, “Page grammars and page parsing: a syntactic approach to document layout recognition,” in Proceedings of the Second International Conference on Document Analysis and Recognition, Tsukuba Science City, Japan, 1993, pp. 761-764; Krishnamoorthy, Nagy, Seth, and Viswanathan 1993; E. G. Miller and P. A. Viola, “Ambiguity and constraint in mathematical expression recognition,” in Proceedings of the National Conference of Artificial Intelligence, American Association of Artificial Intelligence, 1998; T. Tokuyasu and P. A. Chou, “Turbo recognition: a statistical approach to layout analysis,” in Proceedings of the SPIE, vol. 4307, San Jose, Calif., 2001, pp. 123-129; and T. Kanungo and S. Mao, “Stochastic language model for style-directed physical layout analysis of documents,” in IEEE Transactions on Image Processing, vol. 5, no. 5, 2003. These prior efforts adopted state-of-the-art approaches in parsing at the time of publication. For example, the work of Krishnamoorthy et al. uses the grammatical and parsing tools available from the programming language community (see, Krishnamoorthy, Nagy, Seth, and Viswanathan 1993) (see also, Conway 1993 and D. Blostein, J. R. Cordy, and R. Zanibbi, “Applying compiler techniques to diagram recognition,” in Proceedings of the Sixteenth International Conference on Pattern Recognition, vol. 3, 2002, pp. 123-136). Similarly, the work by Hull uses probabilistic context free grammars (see, J. F. Hull, “Recognition of mathematics using a two dimensional trainable context-free grammar,” Master's thesis, MIT, June 1996) (see also, Chou 1989, Miller and Viola 1998, and N. Matsakis, “Recognition of handwritten mathematical expressions,” Master's thesis, Massachusetts Institute of Technology, Cambridge, Mass., May 1999).

Recently, there has been a rapid progress in research on grammars in the natural language community. Advances include powerful discriminative models that can be learned directly from data (see, J. Lafferty, A. McCallum, and F. Pereira, “Conditional random fields: Probabilistic models for segmenting and labeling sequence data,” in Proc. 18th International Conf on Machine Learning, Morgan Kaufmann, San Francisco, Calif., 2001, pp. 282-289 and B. Taskar, D. Klein, M. Collins, D. Koller, and C. Manning, “Max-margin parsing,” in Empirical Methods in Natural Language Processing (EMNLP04), 2004). Such models are strictly more powerful than the probabilistic context free grammars (CFG) used in previous document analysis research. Progress has also been made on accelerating the parsing process (see, E. Chamiak, S. Goldwater, and M. Johnson, “Edge-based best-first chart parsing,” in Proceedings of the Fourteenth National Conference on Artificial Intelligence, 1998, pp. 127-133 and D. Klein and C. D. Manning, “A* parsing: Fast exact viterbi parse selection,” Stanford University, Tech. Rep. dbpubs/2002-16, 2001).

The systems and methods herein utilize techniques with a substantial difference from earlier published work in that a discriminative grammar is learned, rather than a generative grammar. The advantages, for example, of discriminative Markov models are well appreciated (see, Lafferty, McCallum, and Pereira 2001). Likewise, the advantages of a discriminative grammar are similarly significant. Many new types of features can be utilized. Additionally, the grammar itself can often be radically simplified.

Structured Layout Grammars

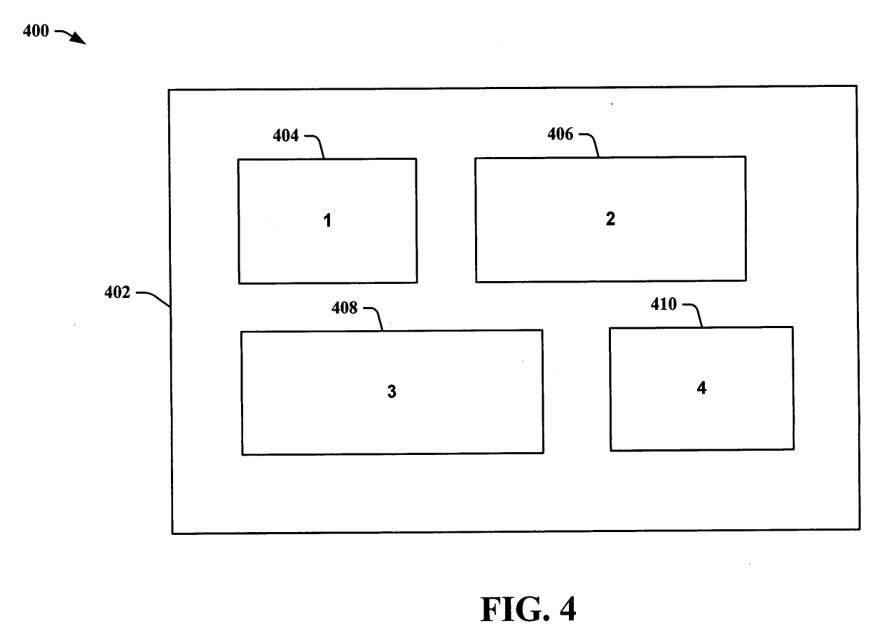

A simple example examined in detail can facilitate in better understanding some intuitions regarding the algorithms presented below. FIG. 4 shows a very simple structured layout 402 (e.g., a document “page”) with four terminal objects 404-410 which, depending on the application, can be, for example, connected components, pen strokes, text lines, etc. In this example, it is assumed that the objects are words on a simple page, and the task is to group the words into lines and lines into paragraphs. A simple grammar that expresses this process utilizing pseudo-code for training the algorithm is shown below in TABLE 1.

TABLE 1
Pseudo-Code for Training Algorithm

```
0) Initialize weights to zero for all productions
1) Parse a set of training examples using current parameters
2) For each production in the grammar
2a) Collect all examples from all charts.
      Examples from the true parse are TRUE.
      All others are FALSE.
2b) Train a classifier on these examples.
2c) Update production weights.
      New weights are the cumulative sum.
3) Repeat Step 1.
```

Consider the following parse for this document shown in TABLE 2 below.

TABLE 2
Document Parse Example

```
(Page (ParList
  (Par (LineList
    (Line (WordList (Word 1)
        (WordList (Word 2))))
    (LineList
      (Line (WordList (Word 3)
          (WordList (Word 4)))))))))
```

This parse tree provides a great deal of information about the document structure: there is one paragraph containing two lines; the first line contains word 1 and word 2, etc.

The grammatical approach can be adopted for many types of structured layout analysis tasks, including the parsing of mathematical expressions, text information extraction, and table extraction. For brevity, focus is restricted to grammars in Chomsky normal form (CNF) (any more general grammar can be easily converted to a CNF grammar), which contains productions such as (A→B C) and (B→b). This first states that the non-terminal symbol A can be replaced by the non-terminal B followed by the non-terminal C. The second states that the non-terminal B can be replaced by terminal symbol b. A simple weighted grammar, or equivalently a Probabilistic Context Free Grammar (PCFG), additionally assigns a cost (or negative log probability) to every production.

While there are a number of competing parsing algorithms, one simple yet generic framework is called “chart parsing” (see, M. Kay, “Algorithm schemata and data structures in syntactic processing,” pp. 35-70, 1986). Chart parsing attempts to fill in the entries of a chart C(A, R). Each entry stores the best score of a non-terminal A as an interpretation of the sub-sequence of terminals R. The cost of any non-terminal can be expressed as the following recurrence:

$$C ( A , {R}_{0} ) = {{{min}_{A \to BC}}_{{R}_{1} ⋂ {R}_{2} = ∅}}_{{R}_{1} ⋃ {R}_{2} = {R}_{0}} C ( B , {R}_{1} ) + C ( C , {R}_{2} ) + l ( A \to BC ) , \qquad ( Eq . 1 )$$

where {BC} ranges over all productions for A, and R₀ is a subsequence of terminals (denoted as a “region”), and R₁ and R₂ are subsequences which are disjoint and whose union is R₀ (i.e., they form a “partition”). Essentially, the recurrence states that the score for A is computed by finding a low cost decomposition of the terminals into two disjoint sets. Each production is assigned a cost (or loss or negative log probability) in a table, l(A→BC). The entries in the chart (sometimes called edges) can be filled in any order, either top down or bottom up. The complexity of the parsing process arises from the number of chart entries that must be filled and the work required to fill each entry. The chart constructed while parsing a linear sequence of N terminals using a grammar including P non-terminals has o(PN²) entries (there are 1/2(2E O(N²)
contiguous subsequences, {i, j} such that 0≦i<j and j<N). Since the work required to fill each entry is O(N), the overall complexity is o(PN³).

Best first parsing (or A-star based parsing) can potentially provide much faster parsing than brute force chart parsing. A-star is a search technique that utilizes a heuristic underestimate to the goal from each state to prune away parts of the search space that cannot possibly result in an optimal solution (see, S. Russell and P. Norvig, “Artificial Intelligence: A Modern Approach,” Prentice Hall, 1995). Performance is dependent on a scoring function which assigns a high score to sub-parses which are part of the correct parse. Machine learning can be employed to facilitate in determining this optimal method of parsing, yielding a scoring function that is trained to provide a parser which parses quickly as well as accurately.

Limitations of Generative Grammars

The basic parsing framework described in Equation 1 provides a modest set of parameters which can be adapted utilizing standard machine learning techniques. There is one parameter for each production in the grammar and, additionally, a set of parameters associated with each terminal type. Models such as these are basically PCFGs, and they lack the expressive power to model many key properties of documents. Stated in another way, the terminals of these models are statistically independent given the parse tree structure (much in the same way the observations of a Markov chain model are independent given the hidden states). For a simple grammar where a paragraph is a collection of lines ((Par→Line Par) and (Par→Line)), the appearance of the lines in a paragraph are independent of each other. Clearly, the lines in a particular paragraph are far from independent, since they share many properties; for example, the lines often have the same margins, or they may all be center justified, or they may have the same interline spacing.

This severe limitation was addressed by researchers for document structure analysis (see, Chou 1989; Hull 1996 and M. Viswanathan, E. Green, and M. Krishnamoorthy, “Document recognition: an attribute grammar approach,” in Proc. SPIE Vol. 2660, p. 101-111, Document Recognition III, Luc M. Vincent; Jonathan J. Hull; Eds., March 1996, pp. 101-111). They replaced the pure PCFG grammar with an attributed grammar. This is equivalent to an expansion of the set of non-terminals. So, rather than a grammar where a paragraph is a set of lines (all independent), the paragraph non-terminal is replaced by a paragraph (Margin, rMargin, lineSpace, justification). The terminal line is then rendered with respect to these attributes. When the attributes are discrete (like paragraph justification), this is exactly equivalent to duplicating the production in the grammar. The result is several types of paragraph non-terminals, for example left, right, and center justified. An explosion in grammar complexity results, with many more productions and much more ambiguity.

Continuous attributes are more problematic still. The only tractable models are those which assume that the attributes of the right hand side (non-)terminals are a simple function of those on the left hand side non-terminals—for example, that the margins of the lines are equal to the margins of the paragraph plus Gaussian noise.

The main, and almost unavoidable, problem with PCFGs is that they are generative. The grammar is an attempt to accurately model the details of the printed page. This includes margin locations, lines spacing, font sizes, etc. Generative models have dominated both in natural language and in related areas such as speech (where the generative Hidden Markov Model is universal (see, L. Rabiner, “A tutorial on hidden markov models,” in IEEE, vol. 77, 1989, pp. 257-286)). Recently, related non-generative discriminative models have arisen. Discriminative grammars allow for much more powerful models of terminal dependencies without an increase in grammar complexity.

Non-Generative Grammatical Models

The first highly successful non-generative grammatical model was the Conditional Random Field (CRF) (see, Lafferty, McCallum, and Pereira 2001 which focuses on Markov chain models which are equivalent to a very simple grammar). Recently, similar insights have been applied to more complex grammatical models (see, Taskar, Klein, Collins, Koller, and Manning 2004). Thus, the production cost in Equation 1 can be generalized considerably without changing the complexity of the parsing process. The cost function can be expressed more generally as:
l(A→BC,R₀,R₁,R₂,doc), (Eq. 2)
which allows the cost to depend on the regions R₀, R₁ and R₂, and even the entire document doc. The main restriction on l( ) is that it cannot depend on the structure of the parse tree utilized to construct B and C (this would violate the dynamic programming assumption underlying chart parsing).

This radically extended form for the cost function provides a substantial amount of flexibility. So, for example, a low cost could be assigned to paragraph hypotheses where the lines all have the same left margin (or the same right margin, or where all lines are centered on the same vertical line). This is quite different from conditioning the line attributes on the paragraph attributes. For example, one need not assign any cost function to the lines themselves. The entire cost of the paragraph hypothesis can fall to the paragraph cost function. The possibilities for cost functions are extremely broad. The features defined below include many types of region measurements and many types of statistics on the arrangements of the terminals (including non-Gaussian statistics). Moreover, the cost function can be a learned function of the visual appearance of the component. This provides unification between the step of OCR, which typically precedes document structure analysis, and the document structure itself.

The main drawback of these extended cost functions is the complexity of parameter estimation. For attributed PCFGs, there are straightforward and efficient algorithms for maximizing the likelihood of the observations given the grammar. So, for example, the conditional margins of the lines are assumed to be Gaussian and then the mean and the variance of this Gaussian distribution can be computed simply. Training of non-generative models, because of their complex features, is somewhat more complex.

Parameter learning can be made tractable if the cost function is restricted to a linear combination of features:

$$l ( p , {R}_{0} , {R}_{1} , {R}_{2} , doc ) = {\sum }_{i} {λ}_{p , i} {f}_{i} ( {R}_{0} , {R}_{1} , {R}_{2} , doc ) . \qquad ( Eq . 3 )$$

where p is a production from the grammar. While the features themselves can be arbitrarily complex and statistically dependent, learning need only estimate the linear parameters λ_{p,i}.
Grammar Learning

The goal of training is to find the parameters λ that maximize some optimization criterion, which is typically taken to be the maximum likelihood criterion for generative models. A discriminative model assigns scores to each parse, and these scores need not necessarily be thought of as probabilities. A good set of parameters maximizes the “margin” between correct parses and incorrect parses. One way of doing this is using the technique described in B. Tasker, D. Klein, M. Collins, D. Koller, and C. Manning, Max-margin parsing, In Empirical Methods in Natural Language Processing (EMNLP04), 2004. However, a simpler algorithm can be utilized by the systems and methods herein to train the discriminative grammar. This algorithm is a variant of the perceptron algorithm and is based on the algorithm for training Markov models proposed by Collins (see, M. Collins, “Discriminative training methods for hidden markov models: Theory and experiments with perceptron algorithms,” In Proceedings of Empirical Methods in Natural Language Processing (EMNLP02), 2002). Thus, instances of the systems and methods herein provide a substantially simpler algorithm that is both easy to implement and to understand. Learning to parse is similar to learning to classify. A set of parameters is estimated which assigns a low cost to correct grammatical groupings and a high cost to incorrect grammatical groupings. Thus, for example, parameters are determined that assign a high score to valid paragraphs and a low score to invalid paragraphs.

Learning Grammars Using Rounds of Learning

Learning proceeds in rounds (see, for example, TABLE 1). Beginning with an agnostic grammar, whose parameters are all zero, a labeled set of expressions is parsed. Typically, it is exceedingly rare to encounter the correct parse. The simplest variant of the learning approach takes both the incorrect and correct parses and breaks them up into examples for learning. Each example of a production, <p, R₁,R₂,doc>, from the correct parse is labeled TRUE, and a production from the incorrect parse is labeled FALSE.

Conversion into a classification problem is straightforward. First the set of features, fᵢ, is utilized to transform example j into a vector of feature values xⱼ. The weights for a given production are adjusted so that the cost for TRUE examples is minimized, and the cost for FALSE examples is maximized (note that the typical signs are reversed since the goal is assign the correct parse a low cost). Given the linear relationship between the parameters and the cost, a simple learning algorithm can be utilized.

The scoring function trained after one round of parsing is then employed to parse the next round. Entries from the new chart are utilized to train the next classifier. The scores assigned by the classifiers learned in subsequent rounds are summed to yield a single final score.

The basic learning process above can be improved in a number of ways. Note that the scoring function can be used to score all chart entries, not just those that appear as part of the best parse. In order to maximize generalization, it is best to train the weights utilizing the true distribution of the examples encountered. The chart provides a rich source of negative examples which lie off the path of the best parse.

The set of examples in the chart, while large, may not be large enough to train the classifier to achieve optimal performance. One scheme for generating more examples is to find the K best parses. The algorithm for K best parsing is closely related to simple chart parsing. The chart is expanded to represent the K best explanations: C(A, R, K), while computation time increases by a factor of K². The resulting chart contains K times as many examples for learning.

It is also important to note that the set of examples observed from early rounds of parsing are not the same as those encountered in later rounds. As the grammar parameters are improved, the parser begins to return parses which are much more likely to be correct. The examples utilized from early rounds do not accurately represent this later distribution. It is important that the weights learned from early rounds not “overfit” these unusual examples. There are many mechanisms designed to prevent overfitting by controlling the complexity of the classifier.

There are many alternative frameworks for learning the set of weights given the training examples described above. Examples include perceptron learning, neural networks, support vector machines, and boosting. Boosting, particularly the AdaBoost algorithm due to Fruend and Schapire (see, Y. Fruend and R. E. Schapire, “A decision-theoretic generalization of on-line learning and an application to boosting,” in Computational Learning Theory: Eurocolt '95, Springer-Verlag, 1995, pp. 23-37) provides, an efficient mechanism both for machine learning and for feature selection. One key advantage of the classification approach is the flexibility in algorithm selection.

Using AdaBoost as an example: in each round of training AdaBoost is used to learn a voted collection of decision trees. Each tree selects a subset of the available features to compute a classifier for the input examples.

Perceptron Learning of Grammars

An alternative, perhaps simpler, scheme for learning proceeds without the need for rounds of parsing and training.

Suppose that T is the collection of training data {(wⁱ,l^{a},T^{a})|1≦i≦m}, where wⁱ=w₁ⁱw₂ⁱ . . . wₙ_{ᵢ}ⁱ is a collection of components, lⁱ=l₁ⁱl₂ⁱ . . . lₙ_{ᵢ}ⁱ is a set of corresponding labels, and Tⁱ is the parse tree. For each rule R in the grammar, a setting of the parameters λ(R) is sought so that the resulting score is maximized for the correct parse Tⁱ of wⁱ for 0≦i≦m. This algorithm for training is shown in TABLE 3 below. Convergence results for the perceptron algorithm appear in (see, Y. Freund and R. Schapire, “Large margin classification using the perceptron algorithm,” Machine Learning, 37(3):277-296 and Collins 2002) when the data is separable. In Collins 2002 some, generalization results for the inseparable case are also given to justify the application of the algorithm.

TABLE 3
Adapted Perceptron Training Algorithm

```
for r [symbol] 1 ... numRounds do
  for i [symbol] 1 ... m do
    T [symbol] optimal parse of wⁱ with current parameters
    if T ≠ Tⁱ then
      for each rule R used in T but not in Tⁱ do
        if feature fⱼ is active in wⁱ then
          λⱼ(R) [symbol] λⱼ(R) − 1;
        endif
      endfor
      for each rule R used in T^{j} but not in T do
        if feature fⱼ is active in wⁱ then
          λⱼ(R) [symbol] λⱼ(R) + 1;
        endif
      endfor
    endif
  endfor
endfor
```

This technique can be extended to train on the N-best parses, rather than just the best. It can also be extended to train all sub-parses as well (i.e., parameters are adjusted so that the correct parse of a sub-tree is assigned the highest score.

Additional Applications

The systems and methods provided herein provide a framework with substantial flexibility and effectiveness, and, thus, are applicable in a wide range of structured recognition problems. These can include, but are not limited to, not only document analysis, but also equation recognition, segmentation and recognition of ink drawings, document table extraction, and web page structure extraction. In general, the key differences between applications are: (1) the grammar used to describe the documents; (2) the set of features used to compute the cost functions; and (3) the geometric constraints used to prune the set of admissible regions. Once these determinations are made, training data is utilized to set the parameters of the model.

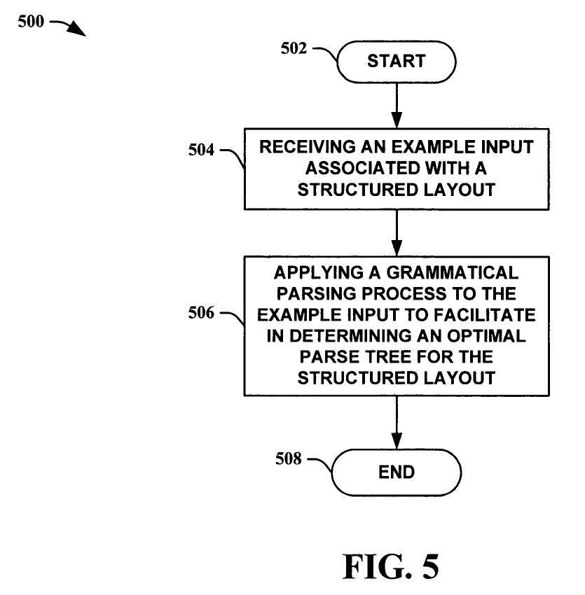

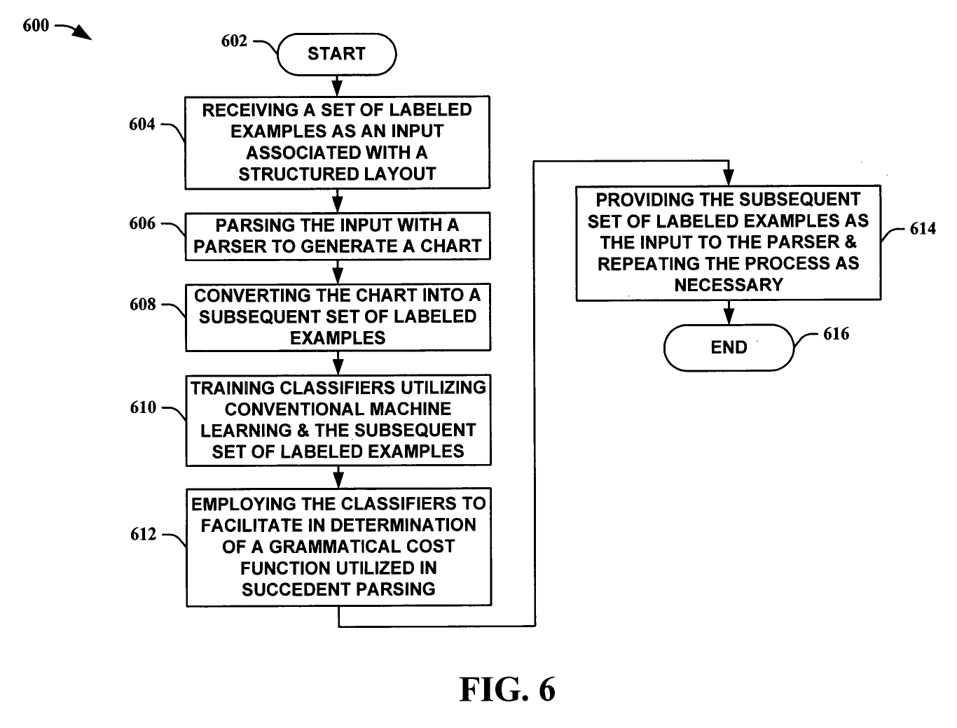

In view of the exemplary systems shown and described above, methodologies that may be implemented in accordance with the subject invention will be better appreciated with reference to the flow charts of FIGS. 5 and 6. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

In FIG. 5, a flow diagram of a method 500 of facilitating structured layout analysis in accordance with an aspect of the subject invention is shown. The method 500 starts 502 by receiving an example input associated with a structured layout 504. The structured layout can include, but is not limited to, handwritten and/or printed documents and the like. This can include structured layouts that contain images and/or other non-text information. The input can include, for example, a set of labeled examples of the structured layout. For example, if the structured layout is a document, the input can include labeled groupings associated with a page of the document and the like. A grammatical parsing process is then applied to the example input to facilitate in determining an optimal parse tree for the structured layout 506, ending the flow 508. The grammatical parsing process can include, but is not limited to, processes employing machine learning and the like to construct classifiers that facilitate a grammatical cost function. The machine learning can include, but is not limited to, conventional machine learning techniques such as for example, perceptron-based techniques and the like.

Looking at FIG. 6, another flow diagram of a method 600 of facilitating structured layout analysis in accordance with an aspect of the subject invention is illustrated. The method 600 starts 602 by receiving a set of labeled examples as an input associated with a structured layout 604. The input is then parsed via a parser to generate a chart 606. The chart is then converted into a subsequent set of labeled examples 608. In other instances, best fit parsing (or A-star parsing) is utilized instead of chart parsing. Classifiers are then trained utilizing conventional machine learning and the subsequent set of labeled examples 610. The conventional machine learning can include, but is not limited to, perceptron-based learning and the like. The training can include, but is not limited to, determination of identifying properties that distinguish positive and negative examples of the input. Other instances can include a classifier for each type of input example. The trained classifiers are then employed to facilitate in determination of a grammatical cost function utilized in succedent parsing 612. The subsequent set of labeled examples is then input into the parser for parsing, and the process is repeated as necessary 614, ending the flow 616. The iterative cycle can be halted when, for example, a grammatical cost cannot be decreased any further, thus, producing an optimal parse tree for the structured layout. The parsing is based on a global search such that an optimal parse tree is optimized globally rather than locally. In some instances, the costs of each round of parsing are accumulated to facilitate in determining an overall cost of the optimal parse tree.

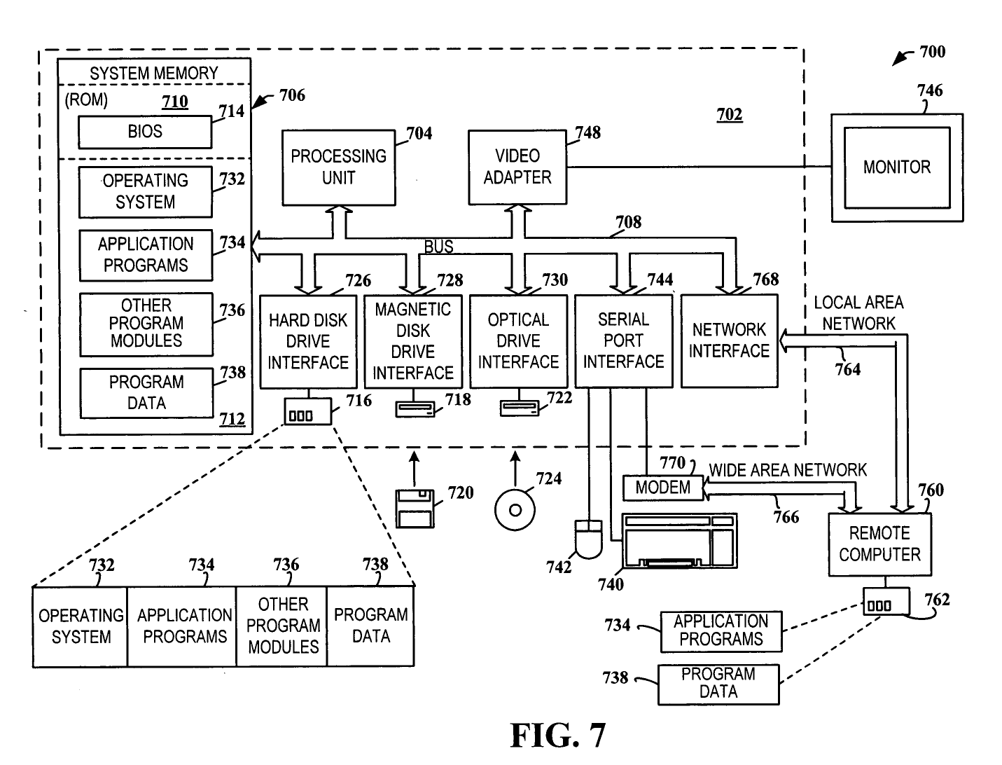

In order to provide additional context for implementing various aspects of the subject invention, FIG. 7 and the following discussion is intended to provide a brief, general description of a suitable computing environment 700 in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 7, an exemplary system environment 700 for implementing the various aspects of the invention includes a conventional computer 702, including a processing unit 704, a system memory 706, and a system bus 708 that couples various system components, including the system memory, to the processing unit 704. The processing unit 704 may be any commercially available or proprietary processor. In addition, the processing unit may be implemented as multi-processor formed of more than one processor, such as may be connected in parallel.

The system bus 708 may be any of several types of bus structure including a memory bus or memory controller, a peripheral bus, and a local bus using any of a variety of conventional bus architectures such as PCI, VESA, Microchannel, ISA, and EISA, to name a few. The system memory 706 includes read only memory (ROM) 710 and random access memory (RAM) 712. A basic input/output system (BIOS) 714, containing the basic routines that help to transfer information between elements within the computer 702, such as during start-up, is stored in ROM 710.

The computer 702 also may include, for example, a hard disk drive 716, a magnetic disk drive 718, e.g., to read from or write to a removable disk 720, and an optical disk drive 722, e.g., for reading from or writing to a CD-ROM disk 724 or other optical media. The hard disk drive 716, magnetic disk drive 718, and optical disk drive 722 are connected to the system bus 708 by a hard disk drive interface 726, a magnetic disk drive interface 728, and an optical drive interface 730, respectively. The drives 716-722 and their associated computer-readable media provide nonvolatile storage of data, data structures, computer-executable instructions, etc. for the computer 702. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 700, and further that any such media may contain computer-executable instructions for performing the methods of the subject invention.

A number of program modules may be stored in the drives 716-722 and RAM 712, including an operating system 732, one or more application programs 734, other program modules 736, and program data 738. The operating system 732 may be any suitable operating system or combination of operating systems. By way of example, the application programs 734 and program modules 736 can include a recognition scheme in accordance with an aspect of the subject invention.

A user can enter commands and information into the computer 702 through one or more user input devices, such as a keyboard 740 and a pointing device (e.g., a mouse 742). Other input devices (not shown) may include a microphone, a joystick, a game pad, a satellite dish, a wireless remote, a scanner, or the like. These and other input devices are often connected to the processing unit 704 through a serial port interface 744 that is coupled to the system bus 708, but may be connected by other interfaces, such as a parallel port, a game port or a universal serial bus (USB). A monitor 746 or other type of display device is also connected to the system bus 708 via an interface, such as a video adapter 748. In addition to the monitor 746, the computer 702 may include other peripheral output devices (not shown), such as speakers, printers, etc.

It is to be appreciated that the computer 702 can operate in a networked environment using logical connections to one or more remote computers 760. The remote computer 760 may be a workstation, a server computer, a router, a peer device or other common network node, and typically includes many or all of the elements described relative to the computer 702, although for purposes of brevity, only a memory storage device 762 is illustrated in FIG. 7. The logical connections depicted in FIG. 7 can include a local area network (LAN) 764 and a wide area network (WAN) 766. Such networking environments are commonplace in offices, enterprise-wide computer networks, intranets and the Internet.

When used in a LAN networking environment, for example, the computer 702 is connected to the local network 764 through a network interface or adapter 768. When used in a WAN networking environment, the computer 702 typically includes a modem (e.g., telephone, DSL, cable, etc.) 770, or is connected to a communications server on the LAN, or has other means for establishing communications over the WAN 766, such as the Internet. The modem 770, which can be internal or external relative to the computer 702, is connected to the system bus 708 via the serial port interface 744. In a networked environment, program modules (including application programs 734) and/or program data 738 can be stored in the remote memory storage device 762. It will be appreciated that the network connections shown are exemplary and other means (e.g., wired or wireless) of establishing a communications link between the computers 702 and 760 can be used when carrying out an aspect of the subject invention.

In accordance with the practices of persons skilled in the art of computer programming, the subject invention has been described with reference to acts and symbolic representations of operations that are performed by a computer, such as the computer 702 or remote computer 760, unless otherwise indicated. Such acts and operations are sometimes referred to as being computer-executed. It will be appreciated that the acts and symbolically represented operations include the manipulation by the processing unit 704 of electrical signals representing data bits which causes a resulting transformation or reduction of the electrical signal representation, and the maintenance of data bits at memory locations in the memory system (including the system memory 706, hard drive 716, floppy disks 720, CD-ROM 724, and remote memory 762) to thereby reconfigure or otherwise alter the computer system's operation, as well as other processing of signals. The memory locations where such data bits are maintained are physical locations that have particular electrical, magnetic, or optical properties corresponding to the data bits.

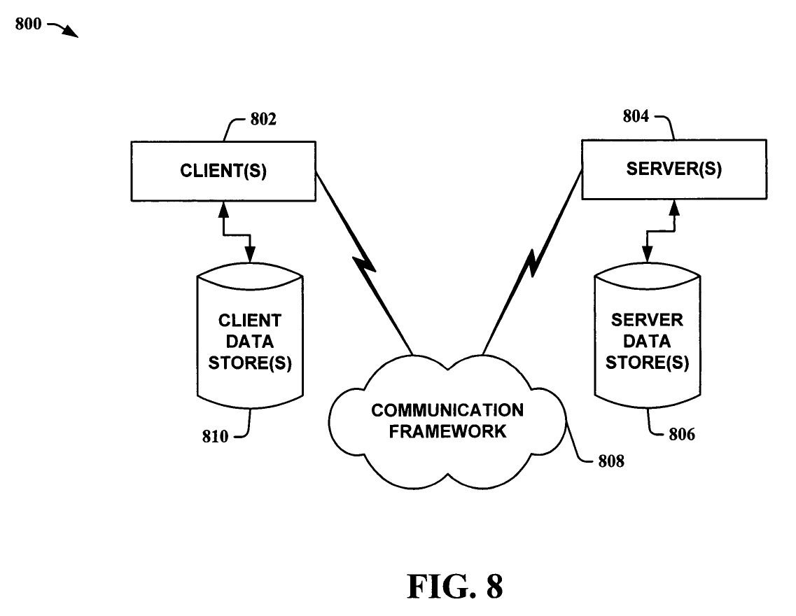

FIG. 8 is another block diagram of a sample computing environment 800 with which the subject invention can interact. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the subject invention can be utilized in recognition facilitating computer components and non-computer related components alike. Further, those skilled in the art will recognize that the systems and/or methods of the subject invention are employable in a vast array of electronic related technologies, including, but not limited to, computers, servers and/or handheld electronic devices, and the like.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates recognition, comprising:
a receiving component that receives an example input associated with a structured layout; and
a grammar component that applies a grammatical parsing process to the example input to facilitate in determining an optimal parse tree for the structured layout.

2. The system of claim 1, the structured layout comprising a layout of a handwritten and/or printed document.

3. The system of claim 1, the grammar component further comprising:
a parsing component that employs at least one classifier to facilitate in determining an optimal parse from a global search.

4. The system of claim 3, the parsing component employs the classifier to facilitate in determining a grammatical cost function.

5. The system of claim 3, the classifier comprising a classifier trained via a conventional machine learning technique.

6. The system of claim 5, the machine learning technique comprising, at least in part, a perceptron-based technique.

7. The system of claim 1, the grammar component utilizes a grammatical parsing process based on, at least in part, a discriminative grammatical model.

8. The system of claim 1, the grammar component employs, at least in part, dynamic programming to determine the optimal parse tree for the structured layout.

9. A method for facilitating recognition, comprising:
receiving an example input associated with a structured layout; and
applying a grammatical parsing process to the example input to facilitate in determining an optimal parse tree for the structured layout.

10. The method of claim 9, the grammatical parsing process based on a discriminative grammatical model.

11. The method of claim 9 further comprising:
parsing the example input based on a grammatical cost function; the grammatical cost function derived, at least in part, via a machine learning technique that facilitates in determining an optimal parse from a global search.

12. The method of claim 9 further comprising:
receiving a set of labeled examples as the input associated with the structured layout;
parsing the set of labeled examples to generate a chart;
converting the chart into a subsequent set of labeled examples;
training classifiers utilizing conventional machine learning and the subsequent set of labeled examples; and
employing the classifiers to facilitate in determination of a grammatical cost function utilized in succedent parsing.

13. The method of claim 12 further comprising:
utilizing the classifiers to determine identifying properties between positive and negative examples of the input.

14. The method of claim 12, the conventional machine learning comprising a perceptron-based learning technique.

15. The method of claim 9, the structured layout comprising a layout of a handwritten and/or printed document.

16. The method of claim 9 further comprising:
utilizing best first parsing (A-star) to facilitate performance of the grammatical parsing process.

17. A system that facilitates recognition, comprising:
means for receiving an example input associated with a structured layout; and
means for applying a grammatical parsing process to the example input to facilitate in determining an optimal parse tree for the structured layout.

18. The system of claim 17 further comprising:
means for parsing the structured layout utilizing at least one classifier trained via a machine learning technique.

19. A device employing the method of claim 9 comprising at least one selected from the group consisting of a computer, a server, and a handheld electronic device.

20. A document structure recognition system employing the system of claim 1.
